(19) United States
(12) Patent Application Publication
(10) Pub. No.: US 2011/0060088 A1
(43) Pub. Date: Mar. 10, 2011

(54) THERMOPLASTIC RESIN COMPOSITION, AND MOLDED ARTICLE

(75) Inventor: Yusuke Hayata, Chiba (JP)

(73) Assignee: IDEMITSU KOSAN CO., LTD., Tokyo (JP)

(21) Appl. No.: 12/991,286

(22) PCT Filed: Apr. 30, 2009
(86) PCT No.: PCT/JP09/58512

§ 371 Date: Nov. 5, 2010

(30) Foreign Application Priority Data
May 7, 2008 (JP) 2008-121600

(51) Int. Cl. C08K 3/34

(52) U.S. Cl. 524/451

(57) ABSTRACT

Provided is a thermoplastic resin composition, including: (A) a resin mixture including 95 to 5 mass % of (a-1) an aromatic polycarbonate resin and 5 to 95 mass % of (a-2) an aliphatic polyester; 5 to 30 parts by mass of (B) talc with respect to 100 parts by mass of the resin mixture; and 0.01 to 1 part by mass of (C) silica with respect to 100 parts by mass of the resin mixture, in which (C) the silica has an average particle diameter of 0.01 to 3 μm and a specific surface area of 50 to 400 m²/g. The thermoplastic resin composition has remarkably improved flame retardancy and remarkably improved heat resistance without using any flame retardant agent, and is excellent in chemical resistance, impact resistance, and fluidity. Also provided is a molded article using the thermoplastic resin composition.

### TECHNICAL FIELD

The present invention relates to a thermoplastic resin composition and a molded article, and more specifically, to a thermoplastic resin composition suitable as, for example, casings for OA instruments, electrical and electronic instruments, and communication instruments, having excellent flame retardancy and excellent heat resistance, and excellent in chemical resistance, impact resistance, and fluidity, and a molded article of the thermoplastic resin composition.

### BACKGROUND ART

Polycarbonates have been frequently utilized in an automobile field, and electrical and electronic fields because of their excellent heat resistance and excellent impact resistance. In the automobile field, and the electrical and electronic fields, thinning has been progressing as a result of the weight reduction of a product, and a blend of a polycarbonate and an ABS resin or AS resin has gone mainstream in order that the fluidity of the polycarbonate maybe improved. Blending the ABS resin can improve not only the fluidity but also the impact resistance and chemical resistance. Alternatively, the chemical resistance can be improved by turning a polyester and the polycarbonate into an alloy.

In recent years, the development of the following plastic products has also been progressing. That is, a plant ratio in each of the products is increased by compounding a plant-derived component, and the products show consideration for an environment. Aliphatic polyesters, and copolymers of the aliphatic polyesters and other polyesters are in the mainstream of plant-derived plastics, and the addition of any such plastic to a polycarbonate can improve the fluidity and the chemical resistance. The development of a resin composition blended with a polylactic acid out of the aliphatic polyesters has been progressing because of the heat resistance and durability of the polylactic acid.

For example, a technology involving adding a phosphate to a resin composition formed of a polycarbonate and a polylactic acid to improve flame retardancy has been proposed (see, for example, Patent Documents 1 and 2). However, the addition of the phosphate reduces the heat resistance of the resin composition, and hence concerns are raised about deformation at the time of molding and long-term heat resistance.

### CITATION LIST

### Patent Literature

[PTL 1] JP 2006-182994 A

[PTL 2] JP 2007-246845 A

### DISCLOSURE OF THE INVENTION

### Problems to be Solved by the Invention

An object of the present invention is to provide a thermoplastic resin composition having remarkably improved flame retardancy and remarkably improved heat resistance without using any flame retardant agent, and excellent in chemical resistance, impact resistance, and fluidity, and a molded article using the thermoplastic resin composition.

### Means for Solving the Problems

The inventors of the present invention have made extensive studies to achieve the above object. As a result, the inventors have found that the above object can be achieved by compounding specific silica into a resin composition based on an aromatic polycarbonate resin and an aliphatic polyester. The present invention has been completed on the basis of such finding.

That is, the present invention provides the following thermoplastic resin composition and molded article.
1. A thermoplastic resin composition, comprising: (A) a resin mixture including 95 to 5 mass % of (a-1) an aromatic polycarbonate resin and 5 to 95 mass % of (a-2) an aliphatic polyester; 5 to 30 parts by mass of (B) talc with respect to 100 parts by mass of the resin mixture; and 0.01 to 1 part by mass of (C) silica with respect to 100 parts by mass of the resin mixture, wherein (C) the silica has an average particle diameter of 0.01 to 3 μm and a specific surface area of 50 to 400 m²/g.
2. The thermoplastic resin composition according to the above item 1, wherein the component (a-2) comprises at least one kind selected from a polylactic acid, copolymers of lactic acids and other hydroxycarboxylic acids, and a polybutylene succinate.
3. The thermoplastic resin composition according to the above item 1, wherein the component (a-1) contains a silicone-copolymerized polycarbonate at a content of 5 to 50 mass % on the basis of an amount of the component (A).
4. The thermoplastic resin composition according to the above item 3, wherein a silicone of the silicone-copolymerized polycarbonate comprises a polyorganosiloxane.
5. The thermoplastic resin composition according to any one of the above items 1 to 4, further including 0.1 to 2 parts by mass of (D) a polytetrafluoroethylene with respect to 100 parts by mass of the component (A).
6. A molded article obtained by using the thermoplastic resin composition according to any one of the above items 1 to 5.
7. A casing for an OA instrument, electrical and electronic instrument, or communication instrument, the casing being obtained by using the thermoplastic resin composition according to any one of the above items 1 to 5.

### Effects of the Invention

According to the present invention, there can be provided a thermoplastic resin composition having remarkably improved flame retardancy and remarkably improved heat resistance without using any flame retardant agent, and excellent in chemical resistance and impact resistance, and a molded article using the thermoplastic resin composition by compounding specific silica into a resin composition based on an aromatic polycarbonate resin and an aliphatic polyester. Further, there can be provided a thermoplastic resin composition excellent in fluidity by selecting a polylactic acid resin as the aliphatic polyester.

### BRIEF DESCRIPTION OF THE DRAWINGS

FIG. 1 is a perspective view of a test piece-mounting jig for evaluating a composition of the present invention for its chemical resistance.

### MODE FOR CARRYING OUT THE INVENTION

Hereinafter, the present invention is described in detail.

A thermoplastic resin composition of the present invention contains (A) a resin mixture comprising (a-1) an aromatic polycarbonate resin and (a-2) an aliphatic polyester, (B) talc, and (C) silica, and as required, (D) a polytetrafluoroethylene.

[(a-1) Aromatic Polycarbonate Resin]

The thermoplastic resin composition of the present invention is a resin composition containing (a-1) the aromatic polycarbonate resin (which may hereinafter be abbreviated as “aromatic PC resin”).

The component (a-1) in the component (A) of the present invention is an aromatic PC resin having a terminal group represented by the following general formula (1).

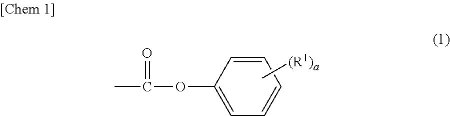

In the general formula (1), R¹ represents an alkyl group having 1 to 35 carbon atoms, the alkyl group may be linear or branched, and its bonding position, which may be any one of para, meta, and ortho positions, is preferably the para position, and a represents an integer of 0 to 5. The aromatic PC resin has a viscosity-average molecular weight of typically 10,000 to 90,000, preferably 13,000 to 30,000 in terms of the impartment of heat resistance, flame retardancy, and impact resistance, or more preferably 15,000 to 24,000.

It should be noted that the viscosity-average molecular weight (Mv) is a value calculated from an equation “[η]=1.23×10⁻⁵ Mv^{0.83}” where [η] represents a limiting viscosity determined by measuring the viscosity of a methylene chloride solution at 20° C. with an Ubbelohde viscometer.

The aromatic polycarbonate having the terminal group represented by the above general formula (1) can be easily produced by causing a dihydric phenol and phosgene or a carbonate compound to react with each other. That is, the aromatic polycarbonate is produced by, for example, a reaction between the dihydric phenol and a carbonate precursor such as phosgene or an ester exchange reaction between the dihydric phenol and a carbonate precursor such as diphenyl carbonate in a solvent such as methylene chloride in the presence of a catalyst such as triethylamine and a specific terminal stopper.

Examples of the dihydric phenol include compounds each represented by the following general formula (2).

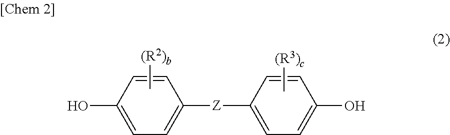

R² and R³ each represent an alkyl group having 1 to 6 carbon atoms or a phenyl group, and may be identical to or different from each other. Z represents a single bond, an alkylene group having 1 to 20 carbon atoms, an alkylidene group having 2 to 20 carbon atoms, a cycloalkylene group having 5 to 20 carbon atoms, a cycloalkylidene group having 5 to 20 carbon atoms, or a —SO₂—, —SO—, —S—, —O—, or —CO— bond, or preferably an isopropylidene group, and b and c each represent an integer of 0 to 4, or preferably 0.

Examples of the above-mentioned dihydric phenol represented by the general formula (2) include: 4,4′-dihydroxydiphenyl; bis(4-hydroxyphenyl)alkanes such as 1,1-bis(4-hydroxyphenyl)methane, 1,1-bis(4-hydroxyphenyl)ethane, and 2,2-bis(4-hydroxyphenyl)propane; bis(4-hydroxyphenyl)cycloalkane; bis(4-hydroxyphenyl)oxide; bis(4-hydroxyphenyl)sulfide; bis(4-hydroxyphenyl)sulfone; bis(4-hydroxyphenyl)sulfoxide; bis(4-hydroxyphenyl)ketone; and the like. Of those, 2,2-bis(4-hydroxyphenyl)propane (bisphenol A) is preferred.

The dihydric phenol may be a homopolymer using one kind of the above dihydric phenols, or may be a copolymer using two or more kinds of them. Further, a thermoplastic, randomly branched polycarbonate obtained by using a polyfunctional aromatic compound and any one of the above dihydric phenols in combination is permitted.

Examples of the carbonate compound include: diaryl carbonates such as diphenyl carbonate; and dialkyl carbonates such as dimethyl carbonate and diethyl carbonate.

A phenol compound from which the terminal group represented by the general formula (1) is formed, that is, a phenol compound represented by the following general formula (3) has only to be used as the terminal stopper. In the following general formula (3), R¹ and a each have the same meaning as that described above.

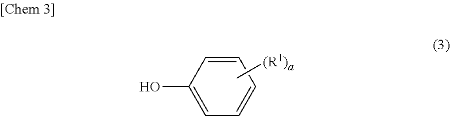

Examples of the phenol compound include phenol, p-cresol, p-tert-butylphenol, p-tert-pentylphenol, p-tert-octylphenol, p-cumylphenol, p-nonylphenol, dococylphenol, tetracocylphenol, hexacocylphenol, octacocylphenol, triacontylphenol, dotriacontylphenol, tetratriacontylphenol, or the like. One kind of the phenol compounds may be used alone, or two or more kinds thereof may be used in combination. In addition, any one of those phenol compounds may be used in combination with, for example, any other phenol compound as required.

It should be noted that the aromatic polycarbonate produced by the above method practically has the terminal group represented by the general formula (1) at one terminal, or each of both terminals, of any one of its molecules.

In the present invention, the aromatic PC resin as the above component (a-1) preferably contains a silicone-copolymerized polycarbonate. In particular, the silicone of the silicone-copolymerized polycarbonate is preferably a polyorganosiloxane in terms of improvements in heat resistance, flame retardancy, and impact resistance.

In the case of, for example, an aromatic polycarbonate-polyorganosiloxane copolymer (which may hereinafter be abbreviated as “aromatic PC-POS copolymer”), the POS is more preferably a polydimethylsiloxane.

The aromatic PC-POS copolymer has a terminal group represented by the following general formula (4), and examples of the copolymer include copolymers disclosed in Japanese Patent Application Laid-open No. Sho 50-29695, Japanese Patent Application Laid-open No. Hei 3-292359, Japanese Patent Application Laid-open No. Hei 4-202465, Japanese Patent Application Laid-open No. Hei 8-81620, Japanese Patent Application Laid-open No. Hei 8-302178, and Japanese Patent Application Laid-open No. Hei 10-7897. In the following general formula (4), an alkyl group having 1 to 35 carbon atoms represented by R⁴ may be linear or branched, and its bonding position, which may be any one of para, meta, and ortho positions, is preferably the para position, and d represents an integer of 0 to 5.

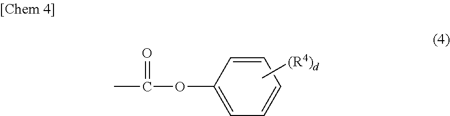

Preferred examples of the aromatic PC-POS copolymer include copolymers each having, in any one of its molecules, a polycarbonate segment formed of a structural unit represented by the following general formula (5) and a polyorganosiloxane segment formed of a structural unit represented by the following general formula (6).

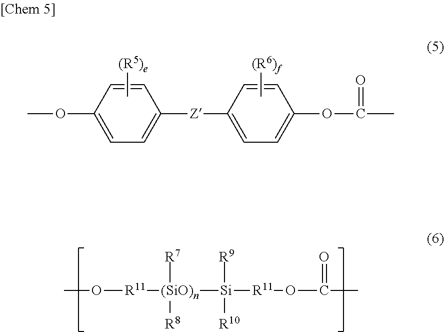

R⁵ and R⁶ each represent an alkyl group having 1 to 6 carbon atoms or a phenyl group, and may be identical to or different from each other, R⁷ to R¹⁰ each represent an alkyl group having 1 to 6 carbon atoms or a phenyl group, or preferably a methyl group, and R⁷ to R¹⁰ may be identical to or different from one another, and R¹¹ represents a divalent organic group containing an aliphatic or aromatic group, or preferably a divalent group represented by any one of the following formulae.

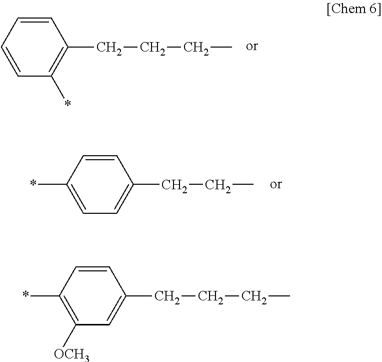

(The mark * represents a bond to be bonded to the oxygen atom.)

Z′ represents a single bond, an alkylene group having 1 to 20 carbon atoms, an alkylidene group having 2 to 20 carbon atoms, a cycloalkylene group having 5 to 20 carbon atoms, a cycloalkylidene group having 5 to 20 carbon atoms, or a —SO₂—, —SO—, —S—, —O—, or —CO— bond, or preferably an isopropylidene group, and e and f each represent an integer of 0 to 4, or preferably 0. n represents an integer of 1 to 500, preferably 5 to 200, more preferably 15 to 300, or still more preferably 30 to 150.

The aromatic PC-POS copolymer can be produced by, for example, a method involving: dissolving a polycarbonate oligomer (hereinafter abbreviated as “PC oligomer”) of which the polycarbonate segment is constituted and a polyorganosiloxane having a reactive group —R¹¹—OH (where R¹¹ has the same meaning as that described above) at a terminal (reactive POS) of which the polyorganosiloxane segment is constituted, the PC oligomer and the reactive POS being produced in advance, in a solvent such as methylene chloride, chlorobenzene, or chloroform; adding an alkali hydroxide solution of a dihydric phenol to the solution; and subjecting the mixture to an interfacial polycondensation reaction with a tertiary amine (such as triethylamine) or a quaternary ammonium salt (such as trimethylbenzylammonium chloride) as a catalyst in the presence of a general terminal stopper formed of a phenol compound represented by the following general formula (7). In the following general formula (7), R⁴ and d each have the same meaning as that described above.

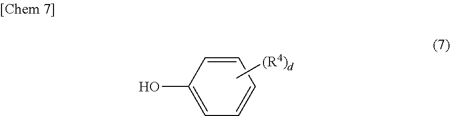

Examples of the phenol compound represented by the above general formula (7) used in the production of the aromatic PC-POS copolymer include the same compounds as the exemplified compounds of the general formula (3). The content of the above polyorganosiloxane segment is preferably 0.2 to 10 mass % with respect to the aromatic PC-POS copolymer, and is preferably 0.1 to 5 mass % in the thermoplastic resin composition of the present invention.

The PC oligomer used in the production of the aromatic PC-POS copolymer can be easily produced by, for example, a reaction between a dihydric phenol and a carbonate precursor such as phosgene or a carbonate compound, or an ester exchange reaction between the dihydric phenol and a carbonate precursor such as diphenyl carbonate in a solvent such as methylene chloride.

Here, any one of the same compounds as the exemplified compounds of the general formula (2) can be used as the dihydric phenol, and 2,2-bis(4-hydroxyphenyl)propane (bisphenol A) out of the compounds is preferred. Any one of the same compounds as the exemplified compounds can be used as the carbonate compound.

In addition, the PC oligomer may be a homopolymer using one kind of the above dihydric phenols, or may be a copolymer using two or more kinds of them. Further, a thermoplastic, randomly branched polycarbonate obtained by using a polyfunctional aromatic compound and any one of the above dihydric phenols in combination is permitted.

In this case, as a branching agent (polyfunctional aromatic compound), there may be used 1,1,1-tris(4-hydroxyphenyl)ethane, α,α′,α″-tris(4-hydroxyphenyl)-1,3,5-triisopropylbenzene, 1-[α-methyl-α-(4′-hydroxyphenyl)ethyl]-4-[α′,α′-bis(4″-hydroxy phenyl)ethyl]benzene, phloroglucine, trimellitic acid, isatinbis(o-cresol), or the like.

The aromatic PC-POS copolymer, which can be produced as described above, is generally produced as an aromatic polycarbonate containing a polycarbonate-polyorganosiloxane copolymer because an aromatic polycarbonate is produced as a by-product.

It should be noted that the aromatic PC-POS copolymer produced by the above method practically has the aromatic terminal group represented by the general formula (4) at one side, or each of both sides, of any one of its molecules.

[(a-2) Aliphatic Polyester]

At least one kind selected from a polylactic acid, copolymers of lactic acids and other hydroxycarboxylic acids, and a polybutylene succinate is preferably used as (a-2) the aliphatic polyester in the component (A) of the present invention from the viewpoint of the reduction of an environmental load.

The polylactic acid is typically synthesized from a cyclic dimer of lactic acid called a lactide by ring-opening polymerization. A production method for the polylactic acid is disclosed in, for example, U.S. Pat. No. 1,995,970, U.S. Pat. No. 2,362,511, or U.S. Pat. No. 2,683,136.

In addition, the copolymers of the lactic acids and the other hydroxycarboxylic acids are each typically synthesized from the lactide and a cyclic ester intermediate of a hydroxycarboxylic acid by ring-opening polymerization. A production method for each of the copolymers is disclosed in, for example, U.S. Pat. No. 3,635,956 or U.S. Pat. No. 3,797,499.

When a lactic acid-based resin is directly produced by dehydration polycondensation without reliance on ring-opening polymerization, a lactic acid-based resin having a degree of polymerization suitable for the present invention is obtained by polymerization according to the following method. That is, any one of the lactic acids, and as required, any other hydroxycarboxylic acid are subjected to azeotropic dehydration condensation in the presence of preferably an organic solvent, or especially a phenyl ether-based solvent. Further, water is particularly preferably removed from the solvent as a distillate obtained by the azeotropy, and the solvent brought into a substantially anhydrous state is returned to a reaction system.

Any one of L- and D-lactic acids, a mixture of the lactic acids, and the lactide as the dimer of lactic acid can be used as one of the lactic acids as raw materials.

In addition, examples of the other hydroxycarboxylic acids that can be used in combination with the lactic acids include glycolic acid, 3-hydroxybutyric acid, 4-hydroxybutyric acid, 4-hydroxyvaleric acid, 5-hydroxyvaleric acid, and 6-hydroxycaproic acid. Further, cyclic ester intermediates of hydroxycarboxylic acids such as glycolide as the dimer of glycolic acid and ε-caprolactone as the cyclic ester of 6-hydroxycaproic acid can each be used.

Upon production of the lactic acid-based resin, a proper additive such as a molecular weight modifier, a branching agent, or any other modifying agent can also be compounded.

One kind of the lactic acids may be used alone, or two or more kinds of them may be used in combination. The same holds true for the hydroxycarboxylic acids as copolymer components. Further, two or more kinds of the resultant lactic acid-based resins may be used as a mixture.

Natural product-derived polylactic acids are excellent candidates for the aliphatic polyester as the component (a-2) used in the present invention because of their fluidity, and thermal and mechanical properties. Of those, one having a weight-average molecular weight of 30,000 or more is preferred. The term “weight-average molecular weight” as used herein refers to a molecular weight measured by gel permeation chromatography in terms of polymethyl methacrylate (PMMA).

With regard to the contents of the polycarbonate resin as the component (a-1) and the aliphatic polyester as the component (a-2) in the resin mixture as the component (A) in the present invention, the content of the component (a-2) is 5 to 95 mass % when the content of the component (a-1) is 95 to 5 mass. When the content of the component (a-2) is less than 5 mass %, the fluidity becomes insufficient. When the content exceeds 95 mass %, the flame retardancy and the heat resistance reduce. The content of the component (a-2) is preferably 10 to 60 mass % when the content of the component (a-1) is 90 to 40 mass %. The content of the component (a-2) is more preferably 20 to 60 mass % when the content of the component (a-1) is 80 to 40 mass %.

In addition, when the component (a-1) contains the silicone-copolymerized polycarbonate, the content of the silicone-copolymerized polycarbonate is preferably 5 to 50 mass %, or more preferably 10 to 40 mass % in the component (A).

[(B) Talc]

The thermoplastic resin composition of the present invention is a resin composition containing (B) the talc. The incorporation of (B) the talc can improve the flame retardancy.

The talc as the component (B) in the present invention is a water-containing silicate of magnesium, and a general commercially available product can be used as the component. The component is preferably of a plate shape, though its shape is not particularly limited to such an extent that an object of the present invention is achieved.

Further, the component (B) preferably has an average particle diameter of 0.1 to 50 μm. One having an average particle diameter of 0.2 to 20 μm is particularly suitably used.

The component (B) in the present invention is compounded in an amount of 5 to 30 parts by mass with respect to 100 parts by mass of the resin mixture as the component (A). When the amount is less than 5 parts by mass, the flame retardancy cannot be imparted. When the amount exceeds 30 parts by mass, the flame retardancy cannot be imparted, and moreover, the impact resistance and the heat resistance become insufficient. The amount is preferably 5 to 25 parts by mass, or more preferably 10 to 25 parts by mass.

[(C) Silica]

The thermoplastic resin composition of the present invention is a resin composition containing (C) the silica. (C) The silica of the present invention must have an average particle diameter of 0.01 to 3 μm and a specific surface area of 50 to 400 m²/g. The incorporation of (C) the silica can improve the flame retardancy.

An average particle diameter of less than 0.01 μm is not preferred because the flame retardancy becomes insufficient. An average particle diameter in excess of 3 μm is not preferred either because a mechanical strength reduces. In addition, a specific surface area of less than 50 m²/g is not preferred because the mechanical strength reduces. A specific surface area in excess of 400 m²/g is not preferred either because the flame retardancy becomes insufficient.

The component (C) in the present invention is preferably high-purity, anhydrous silica having an SiO₂ content of more than 99.5%, an average particle diameter of 0.05 to 3 μm, and a specific surface area of 50 to 400 m²/g. Such silica is easily available as aerosil or colloidal silica. However, the component is not particularly limited as long as the component is such silica as described above.

It should be noted that the average particle diameter and the specific surface area described above can be typically measured by the following methods.

<Average Particle Diameter of Silica>

The average particle diameter of the silica is measured by observing the silica with a transmission electron microscope (TEM).

### <Specific Surface Area of Silica>

The silica is baked at 450° C. for 3 hours in a stream of nitrogen. After that, nitrogen molecules are caused to adsorb to the surfaces of silica particles at −196° C., and then the specific surface area is measured from data on the desorption/adsorption of the nitrogen molecules by a BET method.

The component (C) in the present invention is compounded in an amount of 0.01 to 1 part by mass with respect to 100 parts by mass of the resin mixture as the component (A). When the amount is less than 0.01 part by mass, an excellent drip-preventing effect cannot be obtained. In addition, when the amount exceeds 1 part by mass, sufficient flame retardancy cannot be obtained, and moreover, a reduction in impact strength or an external appearance failure occurs. The amount is preferably 0.05 to 1 part by mass, or more preferably 0.05 to 0.7 part by mass.

In order that the silica as the component (C) may be finely dispersed in the thermoplastic resin composition of the present invention, a mixture obtained by dispersing the silica in a solvent or the like in advance can also be used in the resin composition. The solvent in this case is preferably water, ethylene glycol, or the like, and a mixture having a silica content of about 5 to 50 mass % is desirably used.

[(D) Polytetrafluoroethylene]

(D) The polytetrafluoroethylene can be added to the thermoplastic resin composition of the present invention as required. The incorporation of the component (D) can impart a molten drip-preventing effect and improve the flame retardancy.

The component (D) in the present invention is not particularly limited as long as the component has a fibril-forming ability. The term “fibril-forming ability” as used herein refers to such a tendency that the molecules of the resin are bonded to each other so as to be of a fibrous shape by an external action such as a shearing force. Examples of the component (D) of the present invention include a polytetrafluoroethylene and a tetrafluoroethylene-based copolymer (such as a tetrafluoroethylene/hexafluoropropylene copolymer). Of those, the polytetrafluoroethylene is preferred.

A PTFE having the fibril-forming ability has an extremely large molecular weight, and its number-average molecular weight determined from a standard specific gravity is typically 500,000 or more, or preferably 500,000 to 10,000,000. To be specific, the PTFE can be obtained by polymerizing tetrafluoroethylene in an aqueous solvent in the presence of sodium, potassium, or ammonium peroxydisulfide under a pressure of about 7 to 700 kPa at a temperature of about 0 to 200° C., or preferably 20 to 100° C.

In addition, a PTFE in the form of an aqueous dispersion as well as a solid can be used, and one classified into Type 3 according to the ASTM standard can be used. Commercially available products classified into Type 3 are, for example, a Teflon (registered trademark) 6-J (trade name, manufactured by DU PONT-MITSUI FLUOROCHEMICALS COMPANY, LTD.), and a Polyflon D-1 and a Polyflon F-103 (trade names, manufactured by Daikin Industries, Ltd.). In addition, commercially available products classified into types except Type 3 are, for example, an Algoflon F5 (trade name, manufactured by Montefluos) and a Polyflon MPAFA-100 (trade name, manufactured by Daikin Industries, Ltd.).

One kind of the above PTFEs each having the fibril-forming ability may be used alone, or two or more kinds of them may be used in combination.

The component (D) in the present invention is preferably added in an amount of 0.1 to 2 parts by mass with respect to 100 parts by mass of the resin mixture as the component (A) in ordinary cases. The component (D) is added for additionally improving the flame retardancy of the thermoplastic resin composition of the present invention. However, no larger improving effect on the flame retardancy is obtained even when the component is added in an amount in excess of 2 parts by mass. As long as the amount is 2 parts by mass or less, pellets can be stably produced because the impact resistance and moldability (external appearance of a molded article) of the resin composition do not risk being adversely affected, and the resin composition can be favorably ejected even at the time of kneading extrusion.

[Additive and Inorganic Filler]

Any other synthetic resin or elastomer, and furthermore, various additives such as an antioxidant, a UV absorber, a light stabilizer, any other flame retardant agent, and a lubricant, other various inorganic fillers, and the like can each be appropriately incorporated into the thermoplastic resin composition of the present invention in addition to the above components (A) to (D) as required to such an extent that an object of the present invention is not impaired.

[Pelletization]

The thermoplastic resin composition of the present invention can be obtained by: compounding (A) the resin mixture including (a-1) the aromatic polycarbonate resin and (a-2) the aliphatic polyester, (B) the talc, and (C) the silica, and (D) the polytetrafluoroethylene, or an additive or an inorganic filler to be used as required according to an ordinary method; and melting and kneading the mixture. The compounding and the kneading in this case can each be performed with an instrument that is typically used such as a ribbon blender, a Henschel mixer, a Banbury mixer, a drum tumbler, a uniaxial screw extruder, a biaxial screw extruder, a co-kneader, or a multi-axial screw extruder. A proper heating temperature in the melting and kneading is typically 240 to 280° C.

[Molded Article Using Thermoplastic Resin Composition]

The thermoplastic resin composition of the present invention can be turned into a molded article by applying a known molding method such as hollow molding, injection molding, extrusion molding, vacuum molding, air-pressure molding, heat bending molding, compression molding, calendar molding, or rotational molding. In particular, the thermoplastic resin composition of the present invention is excellent in flame retardancy and heat resistance. Accordingly, the thermoplastic resin composition is suitably used in sites requested to have those characteristics such as parts for OA instruments, electrical and electronic instruments, and communication instruments, and can be utilized in the fields of, for example, optical members and automobiles.

That is, the present invention also provides a molded article obtained by using the thermoplastic resin composition of the present invention, or especially a casing for an OA instrument, electrical and electronic instrument, or communication instrument.

### Examples

The present invention is described in more detail by way of examples. However, the present invention is by no means limited by these examples.

The components (A) to (D) used in Examples 1 to 15 and Comparative Examples 1 to 11 below are as described below.

### (A) Resin Mixture

(a-1) Aromatic Polycarbonate Resin

A1900: A bisphenol A polycarbonate A1900 (manufactured by Idemitsu Kosan Co., Ltd.) having a viscosity-average molecular weight of 19,000

PC-POS copolymer: An aromatic polycarbonate-polyorganosiloxane copolymer having a viscosity-average molecular weight of 17,000 and a polydimethylsiloxane content of 4.0 mass %, and prepared in conformity with production Example 4 of Japanese Patent Application Laid-open No. 2002-12755

(a-2) Aliphatic Polyester 3001D: A polylactic resin (manufactured by NatureWorks LLC)

GSP1a: A polybutylene succinate, AZ81T (manufactured by Mitsubishi Chemical Corporation)

(B) Talc

Talc 1: A TP-A25 (manufactured by Fuji Talc Industrial Co., Ltd.)

Talc 2: An HT-7000 (manufactured by Harima Chemicals, Inc.)

### (C) Silica

Silica 1: A NYASIL6200 (manufactured by Nyacol Nano Technologies, Inc.) having an average particle diameter of 1.7 μm and a specific surface area of 64 m²/g

Silica 2: A NYASIL5 (manufactured by Nyacol Nano Technologies, Inc.) having an average particle diameter of 1.8 μm and a specific surface area of 279 m²/g

Silica 3 (comparison): An FB-20S (manufactured by DENKI KAGAKU KOGYO KABUSHIKI KAISYA.) having an average particle diameter of 17.0 μm and a specific surface area of 4 m²/g

(D) Polytetrafluoroethylene

PTFE: A CD076 (manufactured by ASAHI GLASS CO., LTD.)

### Examples 1 to 15 and Comparative Examples 1 to 11

After the respective components (A) to (D) had been dried, the respective components were compounded at a ratio shown in each of Tables 1 and 2, and were then uniformly blended with a tumbler. After that, the mixture was supplied to a biaxial extruder with a vent having a diameter of 35 mm (TOSHIBA MACHINE CO., LTD., model name: TEM35), and was then kneaded at a temperature of 260° C. so as to be pelletized.

The resultant pellets were dried at 120° C. for 5 hours. After that, the pellets were subjected to injection molding with an injection molder at a cylinder temperature of 240° C. and a mold temperature of 80° C. Thus, test pieces were obtained.

The physical properties of the resultant test pieces were measured and evaluated by the following methods. Tables 1 and 2 show the results.

<Measurement and Evaluation of Physical Properties of Resin Composition>

### (1) Flame Retardancy

A vertical flame test was performed with test pieces each having a thickness of 1.2 mm or 1.5 mm produced in conformity with the UL standard 94. The test pieces were evaluated for their grades of the UL 94 flammability classes (V-0, V-1, and V-2 in order of decreasing flame retardancy) on the basis of the results of the test, and those not corresponding to these flammability classes were regarded as being nonstandard.

### (2) Chemical Resistance

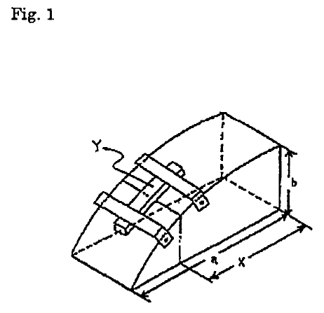

Evaluation was performed in conformity with a chemical resistance evaluation method (critical strain with a quarter ellipse). A test piece (having a thickness of 3 mm) was fixed to a surface of the quarter ellipse illustrated in FIG. 1 (perspective view). Gasoline (Zearth manufactured by Idemitsu Kosan Co., Ltd.) was applied to the test piece, and was then held for 48 hours. The minimum length (X) at which a crack was generated was read, and then the critical strain (%) was determined from the following equation [1]. It should be noted that t in the following equation [1] represents the thickness of the test piece. A larger critical strain (%) means a higher chemical resistance.

$$\begin{matrix}[ Num 1 ] & \\ Critical strain ( \% ) = {\frac{b}{2 {a}^{2}} [ 1 - ( \frac{1}{{a}^{2}} - \frac{{b}^{2}}{{a}^{4}} ) {X}^{2} ]}^{- 3 / 2 \cdot t} & [ 1 ]\end{matrix}$$

### (3) Heat Resistance (Deflection Temperature Under Load)

A deflection temperature under load was measured in accordance with a measurement method described in JIS K 7191 under a load of 1.8 MPa at a temperature of 23° C.

### (4) IZOD Impact Strength (IZOD)

Measurement was performed with a test piece having a thickness of 3.2 mm (⅛ inch) produced with an injection molder in conformity with the ASTM standard D-256.

### (5) Falling Weight Impact Strength

Measurement was performed with a weight of 3.76 kg and a test piece having a thickness of 2 mm in conformity with JIS K 7211 at a falling speed of 5 m/sec and 23° C.

TABLE 1

| | | | Example | | | | | | | |
|---|---|---|---|---|---|---|---|---|---|---|
| | | | 1 | 2 | 3 | 4 | 5 | 6 | 7 | 8 |
| Compounding | (A) | (a-1) A1900 (%)* | 80 | 40 | 40 | 40 | 40 | 40 | 40 | 40 |
| ratio | | (a-1) PC-POS copolymer (%)* | 10 | 30 | 30 | 30 | 30 | 30 | 30 | 30 |
| | | (a-2) 3001D (%)* | 10 | 30 | 30 | 30 | 30 | — | — | — |
| | | (a-2) GSP1a (%)* | — | — | — | — | — | 30 | 30 | 30 |
| | (B) | Talc 1 (part(s)) | 12 | 12 | 12 | 12 | — | 12 | 12 | 12 |
| | | Talc 2 (part(s)) | — | — | — | — | 12 | — | — | — |
| | (C) | Silica 1 (part(s)) | 0.1 | 0.3 | 0.1 | — | 0.1 | 0.05 | 0.05 | — |
| | | Silica 2 (part(s)) | — | — | — | 0.3 | — | — | — | 0.1 |
| | | Silica 3 (comparison)(part(s)) | — | — | — | — | — | — | — | — |

| | (D) PTFE (parts) | | — | — | 0.4 | — | — | — | 0.4 | — |
|---|---|---|---|---|---|---|---|---|---|---|
| Evaluation | (1) Flame | Thickness 1.2 mm | V-0 | V-1 | V-1 | V-1 | V-1 | V-1 | V-1 | V-1 |
| | retardancy | Thickness 1.5 mm | V-0 | V-1 | V-0 | V-1 | V-1 | V-1 | V-0 | V-1 |

| | | | | | | | | |
|---|---|---|---|---|---|---|---|---|
| (2) Chemical resistance (critical | 0.8 | 1.2 | 1.2 | 1.2 | 1.0 | 1.8 | 1.8 | 1.8 |
| strain) [%] | | | | | | | | |
| (3) Heat resistance (under a load of | 135 | 130 | 130 | 130 | 130 | 120 | 120 | 120 |
| 1.8 MPa) [° C.] | | | | | | | | |
| (4) IZOD impact strength [kJ/m²] | 15 | 15 | 12 | 15 | 15 | 30 | 28 | 30 |
| (5) Falling weight impact strength [J] | 30 | 25 | 25 | 25 | 25 | 30 | 30 | 30 |

| | | | Example | | | | | | |
|---|---|---|---|---|---|---|---|---|---|
| | | | 9 | 10 | 11 | 12 | 13 | 14 | 15 |
| Compounding | (A) | (a-1) A1900 (%)* | 40 | — | — | 10 | — | 10 | — |
| ratio | | (a-1) PC-POS copolymer (%)* | 30 | 30 | 30 | 20 | 30 | 20 | 30 |
| | | (a-2) 3001D (%)* | 20 | 70 | 70 | 70 | — | — | 50 |
| | | (a-2) GSP1a (%)* | 10 | — | — | — | 70 | 70 | 20 |
| | (B) | Talc 1 (part(s)) | 12 | 25 | — | 25 | 25 | 25 | 25 |
| | | Talc 2 (part(s)) | — | — | 25 | — | — | — | — |
| | (C) | Silica 1 (part(s)) | 0.05 | 0.7 | 0.7 | 0.7 | 0.7 | 0.7 | 0.7 |
| | | Silica 2 (part(s)) | — | — | — | — | — | — | — |
| | | Silica 3 (comparison)(part(s)) | — | — | — | — | — | — | — |

| | (D) PTFE (parts) | | — | — | — | — | — | — | — |
|---|---|---|---|---|---|---|---|---|---|
| Evaluation | (1) Flame | Thickness 1.2 mm | V-1 | V-2 | V-2 | V-2 | V-2 | V-2 | V-2 |
| | retardancy | Thickness 1.5 mm | V-1 | V-1 | V-1 | V-1 | V-1 | V-1 | V-1 |

| | | | | | | | |
|---|---|---|---|---|---|---|---|
| (2) Chemical resistance (critical | 1.6 | 1.6 | 1.6 | 1.6 | 2.0 | 2.0 | 1.8 |
| strain) [%] | | | | | | | |
| (3) Heat resistance (under a load of | 120 | 105 | 105 | 105 | 95 | 95 | 100 |
| 1.8 MPa) [° C.] | | | | | | | |
| (4) IZOD impact strength [kJ/m²] | 25 | 10 | 10 | 10 | 20 | 20 | 15 |
| (5) Falling weight impact strength [J] | 30 | 20 | 20 | 20 | 20 | 20 | 20 |

(%)*: Mass % in the component (A)
(Part(s)): by mass with respect to 100 parts by mass of the component (A)

TABLE 2

| | | | Comparative Example | | | | | |
|---|---|---|---|---|---|---|---|---|
| | | | 1 | 2 | 3 | 4 | 5 | 6 |
| Compounding | (A) | (a-1) A1900 (%)* | 88 | 40 | 40 | 40 | 40 | 40 |
| ratio | | (a-1) PC-POS copolymer (%)* | 10 | 30 | 30 | 30 | 30 | 30 |
| | | (a-2) 3001D (%)* | 2 | 30 | 30 | 30 | 30 | 30 |
| | | (a-2) GSPla (%)* | — | — | — | — | — | — |
| | (B) | Talc 1 (part(s)) | 12 | 2 | 12 | 12 | 50 | 12 |
| | | Talc 2 (part(s)) | — | — | — | — | — | — |
| | (C) | Silica 1 (part(s)) | 0.1 | 0.1 | — | — | 0.1 | 2 |
| | | Silica 2 (part(s)) | — | — | — | — | — | — |
| | | Silica 3 (comparison) | — | — | — | — | — | — |
| | | (part(s)) | | | | | | |

| | (D) PTFE (part(s)) | | — | — | — | 0.4 | — | — |
|---|---|---|---|---|---|---|---|---|
| Evaluation | (1) Flame | Thickness 1.2 mm | V-1 | Non- | Non- | Non- | Non- | Non- |
| | retardancy | | | standard | standard | standard | standard | standard |
| | | Thickness 1.5 mm | V-0 | Non- | Non- | V-1 | Non- | Non- |
| | | | | standard | standard | | standard | standard |

| | | | | | | |
|---|---|---|---|---|---|---|
| (2) Chemical resistance (critical | 0.2 | 0.9 | 1.2 | 1.2 | 0.9 | 1.2 |
| strain) [%] | | | | | | |
| (3) Heat resistance (under a load of | 125 | 105 | 105 | 105 | 110 | 110 |
| 1.8 MPa) [° C.] | | | | | | |
| (4) IZOD impact strength [kJ/m²] | 15 | 15 | 15 | 10 | 5 | 5 |
| (5) Falling weight impact strength [J] | 20 | 25 | 25 | 25 | 5 | 5 |

| | | | Comparative Example | | | | |
|---|---|---|---|---|---|---|---|
| | | | 7 | 8 | 9 | 10 | 11 |
| Compounding | (A) | (a-1) A1900 (%)* | — | — | 40 | 40 | — |
| ratio | | (a-1) PC-POS copolymer (%)* | 30 | 30 | 30 | 30 | 30 |
| | | (a-2) 3001D (%)* | 70 | 70 | 30 | — | 70 |
| | | (a-2) GSPla (%)* | — | — | — | 30 | — |
| | (B) | Talc 1 (part(s)) | 25 | 50 | 12 | 12 | 25 |
| | | Talc 2 (part(s)) | — | — | — | — | — |
| | (C) | Silica 1 (part(s)) | — | 0.7 | — | — | — |
| | | Silica 2 (part(s)) | — | — | — | — | — |
| | | Silica 3 (comparison) | — | — | 0.1 | 0.1 | 0.7 |
| | | (part(s)) | | | | | |

| | (D) PTFE (part(s)) | | — | — | — | — | — |
|---|---|---|---|---|---|---|---|
| Evaluation | (1) Flame | Thickness 1.2 mm | Non- | Non- | Non- | Non- | Non- |
| | retardancy | | standard | standard | standard | standard | standard |
| | | Thickness 1.5 mm | Non- | Non- | Non- | Non- | Non- |
| | | | standard | standard | standard | standard | standard |

| | | | | | |
|---|---|---|---|---|---|
| (2) Chemical resistance (critical | 1.4 | 1.2 | 1.0 | 1.4 | 1.4 |
| strain) [%] | | | | | |
| (3) Heat resistance (under a load of | 75 | 80 | 105 | 100 | 80 |
| 1.8 MPa) [° C.] | | | | | |
| (4) IZOD impact strength [kJ/m²] | 10 | 2 | 5 | 5 | 5 |
| (5) Falling weight impact strength [J] | 20 | 5 | 5 | 5 | 5 |

(%)*: Mass % in the component (A)
(Part(s)): by mass with respect to 100 parts by mass of the component (A)

Tables 1 and 2 show the following.

### <1>Examples 1 to 15

The present invention enabled the provision of a thermoplastic resin composition having improved flame retardancy and improved heat resistance, and excellent in balance among properties including chemical resistance and impact resistance.

### <2>Comparative Example 1

As can be seen from Comparative Example 1 shown in Table 2, the chemical resistance cannot be obtained when the amount in which (a-1) the aliphatic polyester is compounded is small.

### <3>Comparative Examples 2 to 8

As can be seen from Comparative Examples 2 to 8 shown in Table 2, the flame retardancy, the heat resistance, and the impact resistance are insufficient when the amount in which each of the components (A) to (D) is compounded deviates from the range specified in the present invention.

### <4>Comparative Examples 9 to 11

As can be seen from Comparative Examples 9 to 11 shown in Table 2, the use of silica having a larger average particle diameter than that specified in the present invention significantly reduces the flame retardancy and the impact resistance, and slightly reduces the heat resistance as well.

### INDUSTRIAL APPLICABILITY

The thermoplastic resin composition of the present invention has improved flame retardancy and improved heat resistance by using a polylactic acid or the like as a polyester resin without using any flame retardant agent. In addition, the thermoplastic resin composition of the present invention is excellent in chemical resistance, impact resistance, and fluidity. Accordingly, the thermoplastic resin composition can be widely used in the fields of, for example, optical members and automobiles. Further, the thermoplastic resin composition can be suitably used in the production of casings for OA instruments, electrical and electronic instruments, and communication instruments.

### Description of Symbols

a: bottom length of quarter ellipse jig
b: height of quarter ellipse jig
X: distance to position at which crack is generated
Y: test piece (having thickness of 3 mm)

1. A thermoplastic resin composition, comprising:
(A) a resin mixture comprising 95 to 5 mass % of (a-1) an aromatic polycarbonate resin and 5 to 95 mass % of (a-2) an aliphatic polyester;
(B) 5 to 30 parts by mass of talc with respect to 100 parts by mass of the resin mixture; and
(C) 0.01 to 1 part by mass of silica with respect to 100 parts by mass of the resin mixture,
wherein (C) the silica has an average particle diameter of 0.01 to 3 μm and a specific surface area of 50 to 400 m²/g.

2. The thermoplastic resin composition according to claim 1, wherein the aliphatic polyester (a-2) comprises at least one selected from the group consisting of a polylactic acid, a copolymer of lactic acid and at least one different hydroxycarboxylic acid, and a polybutylene succinate.

3. The thermoplastic resin composition according to claim 1, wherein the aromatic polycarbonate resin (a-1) comprises a silicone-copolymerized polycarbonate at a content of 5 to 50 mass % based on an amount of the resin mixture (A).

4. The thermoplastic resin composition according to claim 3, wherein a silicone of the silicone-copolymerized polycarbonate comprises a polyorganosiloxane.

5. The thermoplastic resin composition according to claim 1, further comprising:
(D) 0.1 to 2 parts by mass of a polytetrafluoroethylene with respect to 100 parts by mass of the resin mixture (A).

6. A molded article, comprising the thermoplastic resin composition according to claim 1.

7. A casing for an OA instrument, electrical instrument, electronic instrument, or communication instrument, the casing comprising the thermoplastic resin composition according to claim 1.

8. The thermoplastic resin composition according to claim 2, further comprising:
(D) 0.1 to 2 parts by mass of a polytetrafluoroethylene with respect to 100 parts by mass of the resin mixture (A).

9. The thermoplastic resin composition according to claim 3, further comprising:
(D) 0.1 to 2 parts by mass of a polytetrafluoroethylene with respect to 100 parts by mass of the resin mixture (A).

10. The thermoplastic resin composition according to claim 4, further comprising:
(D) 0.1 to 2 parts by mass of a polytetrafluoroethylene with respect to 100 parts by mass of the resin mixture (A).

11. The thermoplastic resin composition according to claim 1, wherein the aromatic polycarbonate resin has a terminal group represented by formula (1) 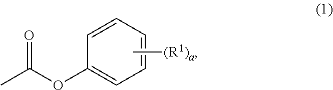
wherein
R¹ represents a branched or linear alkyl group having 1 to 35 carbon atoms, and a represents an integer of 0 to 5.

12. The thermoplastic resin composition according to claim 11, wherein R¹ is bonded to at least one position on the benzene ring selected from the group consisting of a para position, a meta position, and an ortho position, with respect to the ester oxygen.

13. The thermoplastic resin composition according to claim 11, wherein R¹ is bonded to the para position.

14. The thermoplastic resin composition according to claim 1, wherein the aromatic polycarbonate resin has a viscosity-average molecular weight of 10,000 to 40,000.

15. The thermoplastic resin composition according to claim 1, wherein the aromatic polycarbonate resin has a viscosity-average molecular weight of 13,000 to 30,000.

16. The thermoplastic resin composition according to claim 1, wherein the aromatic polycarbonate resin has a viscosity-average molecular weight of 15,000 to 24,000.

17. The thermoplastic resin according to claim 3, wherein the silicone-copolymerized-polycarbonate comprises:
a polycarbonate unit of formula (2) 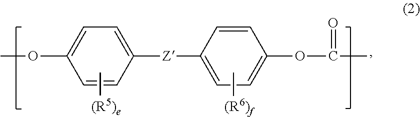
wherein
R⁵ and R⁶ are identical or different and each represent an alkyl group having 1 to 6 carbon atoms or a phenyl group,
Z′ represents a single bond, an alkylene group having 1 to 20 carbon atoms, an alkylidene group having 2 to 20 carbon atoms, a cycloalkylene group having 5 to 20 carbon atoms, a cycloalkylidene group having 5 to 20 carbon atoms, an —SO₂— bond, an —SO— bond, an —S— bond, an —O— bond, or —CO— bond, and
e and f each represent an integer of 0 to 4.
and a polyorganosiloxane unit of formula (3) 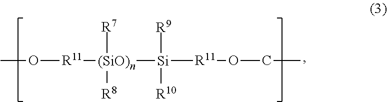
wherein
R⁷ to R¹⁰ are identical or different and each represent an alkyl group having 1 to 6 carbon atoms or a phenyl group, or preferably a methyl group,
R¹¹ represents a divalent organic group comprising an aliphatic or aromatic group, and
n represents an integer of 1 to 500.

18. The thermoplastic resin according to claim 17, wherein Z′ of the polycarbonate unit is an isopropylidene group.

19. The thermoplastic resin according to claim 17, wherein R¹¹ of the polycarbonate unit represents a divalent group represented by formula (4), formula (5), or formula (6): 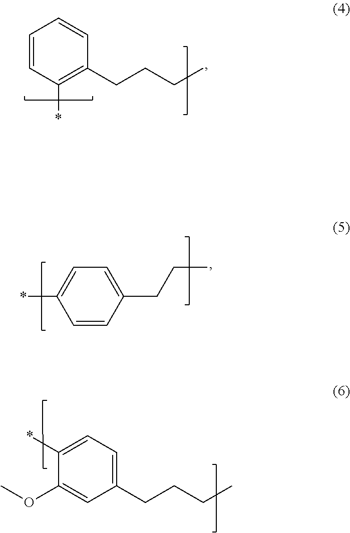
wherein * represents a bonding point to the oxygen atom.

20. The thermoplastic resin of claim 5, wherein the polytetrafluoroethylene has a number-average molecular weight of 500,000 to 10,000,000.
